(19) United States
(12) Patent Application Publication
(10) Pub. No.: US 2015/0236940 A1
(43) Pub. Date: Aug. 20, 2015

(54) Method for monitoring an Ethernet-based communication network in a motor vehicle

(71) Applicant: CONTINENTAL AUTOMOTIVE GMBH, Hannover (DE)

(72) Inventors: Helge Zinner, Magdeburg (DE); Jürgen Röder, Wenzenbach (DE)

(21) Appl. No.: 14/428,898

(22) PCT Filed: Sep. 17, 2013
(86) PCT No.: PCT/EP2013/069217

§ 371 Date: Mar. 17, 2015

(30) Foreign Application Priority Data
Sep. 18, 2012 (DE) 10 2012 216 689.0

(51) Int. Cl. H04L 12/26; H04L 29/08

(52) U.S. Cl. CPC H04L 43/12; H04L 67/10

(57) ABSTRACT

A network for monitoring an Ethernet-based communication network in a motor vehicle monitors the communications connection between two network nodes connected via the communications network. The duration of signals between network nodes of the communication network is measured bidirectionally and cyclically and changes in signal duration are evaluated.

### CROSS-REFERENCE TO RELATED APPLICATIONS

This is a U.S. national stage of application No. PCT/EP2013/069217, filed on 17 Sep. 2013, which claims priority to the German Application No. DE 10 2012 216 689.0 filed September 2012, the content of both incorporated herein by reference.

### BACKGROUND OF THE INVENTION

1. Field of the Invention

The invention relates to a method for monitoring an Ethernet-based communication network in a motor vehicle and to a network node that is set up to carry out the method, for example in the form of a controller. The method is used particularly for monitoring for errors in the communication network and/or for changes in the network topology. To this end, there is provision for monitoring of the communication link between two network nodes, which are particularly in the form of electronic controllers and are connected via the communication network.

2. Related Art

The Ethernet-based communication is effected on the basis of what is known as the OSI layer model, in which each layer is assigned particular tasks that need to be performed by the entities (devices and software) of the respective layer for the communications to work. In this case, each entity of a layer provides services on the basis of the standardized network protocol, the services being able to be used by an overlying entity without having to be concerned with how and with what technical means the underlying entity solves the problems with which it is faced. Through the different layers, there are corresponding interfaces defined.

The bottom two layers, namely the physical layer and the data link layer on the basis of the OSI layer model, are used for physical data transmission, with the bottommost layer (physical layer) providing the tools for activating and deactivating the physical connection and the second-from-bottom layer (data link layer) controlling access to the transmission medium, particularly by media access control (MAC). The data link layer also identifies which subscriber devices participate in the communication as network nodes with their unique MAC address. Therefore, this layer is fundamentally also suitable for monitoring the network for network nodes participating in the communication.

The overlying layers of the OSI layer model prepare the data transmitted during the physical data transmission in stages for distribution to different applications. This does not need to be discussed further for the invention.

Since monitoring of the subscribers on the communication network is fundamentally possible in the network only with knowledge of the addressing of the subscribers, i.e., the MAC addresses or other explicit identification features, thereof, there is a potential for attack in an Ethernet-based communication system in that the connection between two controllers or network nodes on the bottommost layer of the OSI layer model (physical layer) can be broken without the interposed device participating in the actual network communication and having a separate MAC address. Such a device therefore cannot be identified in the data link layer itself.

Such network analyzers as can be inserted, into a communication system in the physical layer of the OSI layer model are referred to as a tap (Test Access Point), which can be added directly to a network connection, for example by looping it into the cable connection. Such taps mirror the full-duplex data traffic on the connection and output the data traffic to an analysis unit or data collection point, which can read the data, connected to the tap, for example. On the basis of the pure data mirroring, the taps are passive components of the communication network that have no MAC or IP address and do not permit backward communication from the sensor connected to the tap into the communication network. Such taps therefore cannot be identified as communication subscribers, and also cannot be addressed, in the network itself.

Particularly for safety-relevant applications, as are present in the motor vehicle, this represents a certain hazard potential. If driver assistance systems transmit evaluated information, for example, it is necessary to establish whether this information is being passively read. Such passive reading can set up a targeted attack on the communication system of the motor vehicle, for example as a result of keys or network addresses used becoming known.

### SUMMARY OF THE INVENTION

It is therefore an object of the present invention to identify intervention in the communication network of the motor vehicle also on the technical physical layer, on which just the physical data traffic is handled.

The invention achieves this object by a method having provision for the physical propagation time of the signals between preferably two respective network nodes of the communication network to be measured bidirectionally and cyclically and for changes in the signal propagation time to be rated.

The background to this inventive concept is that although the taps as data packet copiers do not appear in the network as separate network nodes, i.e., subscribers to the network communication, and hence cannot be identified in the data link layer, they require a particular signal propagation time for copying the data packets and passing the signal through the tap, which signal propagation times extends the signal propagation time in comparison with a direct cable connection between the two network nodes.

While a normal Ethernet, for example for networking computers as an internal or even external network (Internet), is normally not static, which means that the signal propagation times between two network nodes can change possibly relatively frequently even during regular operation, a vehicle network is of static design, because controllers and network nodes are usually replaced only in the event of a fault and this can be accomplished only in a workshop that is authorized to do so. In a static communication network, as is present in a motor vehicle, for example, the signal propagation times do not fluctuate, on the other hand, apart from relatively small, insignificant discrepancies, for example on account of ordinary jitter or temperature-related propagation time differences. The present invention makes use of this property in order to identify, by establishing alterations in the signal propagation time between two network nodes, whether there has been intervention in the static design of the network (network topology), possibly on the bottommost layer (physical layer). On the basis of threshold values or other criteria, for example, it is then possible to rate changes found in the signal propagation time, so that changes in the signal propagation time are established and as a result the communication network as a whole is monitored. By way of example, a signal propagation time can be computed by the parameters of the physical layer (PHY parameters) and the type of cabling (copper, optical fiber, etc.). In the case of a Gigabit Ethernet System with a Cat5e cable, a delay of approximately 400 ns arises between two connected entities of the physical layer (PHY).

According to the invention, the monitoring is effected bidirectionally, i.e., in each communication direction of the communication network, and cyclically, i.e., at prescribed or prescribable intervals of time, so that alterations can reliably be established. The cyclic measurements also allow a distinction between whether, by way of example, device ageing means that a subtle increase in signal propagation time takes place or whether an abrupt change of signal propagation time occurs for signal propagation times that were previously substantially constant over a relatively long period. The latter case indicates that the signal connection between the two network nodes has been broken, and can accordingly be reported as an instance of monitoring.

In a preferred refinement of the proposed method, there may be provision that for the purpose of measuring the signal propagation time of the signals between the network nodes, one network node (subsequently also referred to as the sending network node) sends a query message to the other network node (subsequently also referred to as the receiving network node), which query message contains the transmission time of the query message, and the other (receiving) network node logs the reception time.

The incorporation of the transmission time into the query message can be effected in the form of a transmission time stamp t₁, for example, which is produced by the transceiver of the one (sending) network node, which transceiver sends the message, immediately before sending and is also incorporated into the query message. This approximately achieves measurement of the actual signal propagation time of the signals (data packets). A systematic offset possibly taking place for the actual sending disappears when alterations in the propagation time are considered, since this involves the difference between two signal propagation times being considered in each case.

The reception time can preferably be logged by virtue of a reception time stamp t₂ being produced in the other (receiving) network node, so that the difference between the time values of the reception time stamp t₂ and the initial time stamp t₁ ascertains the signal propagation time.

The other (receiving) network node is therefore immediately able to determine the signal propagation time from the one (sending) network node to the other (receiving) network node and to establish and rate alterations for cyclic measurements.

According to the invention, the role of the sending and receiving network nodes can repeatedly change, since the query messages can be sent cyclically and bidirectionally, i.e., in each communication direction between the two network nodes. The query messages can also be sent in both directions in parallel. In this respect, the present invention consciously refers to the “one” network node and the “other” network node in the communication network. This designation relates to the one measurement of the signal propagation time at a particular instant from a particular network node without the one physical network node always needing to correspond to the “one” network node that sends the query message.

According to a preferred further development of the proposed method for measuring the signal propagation time, the other (receiving) network node can send the reception time of the query message, that is to say particularly the reception time stamp t₂, to the one (originally sending) network node in a response message. As a result, the evaluation can be effected both in the originally sending network node and in the originally receiving network node.

So as also to achieve bidirectional measurement of the signal propagation times for a measurement cycle, it is possible, according to one inventive variant of the proposed method, for the measurement of the signal propagation time to involve the other (receiving) network node logging the transmission time of the response message to the one (originally sending) network node, for example in the form of a response time stamp t₃, which can be produced in a similar manner to the initial time stamp t₁, and sending it to the one (originally sending) network node in a follow-up response message.

The one (originally sending the query message) network node then logs (for example also in the form of a response reception time stamp t₄) the reception time of the follow-up response message, so that the difference between the reception and transmission instants of the follow-up response message can also ascertain the propagation time in the other communication direction of the bidirectional communication link between the network nodes.

Preferably statistical evaluation of the many measured values obtained allows the mean value of the propagation times to be formed and the typical fluctuation range to be ascertained, for example. As soon as a value is outside this fluctuation range to a statistically significant degree, for example outside a 3a range of a Gaussian distribution, a disturbance in the direct communication link is assumed that can be rated as interposition of an additional communication subscriber in the event of the signal propagation time being extended.

In principle, such messages are known as part of measurements of the signal propagation time on the basis of the standards IEEE 1588, IEEE 802.1AS (as part of Ethernet AVB) or of the TTEthernet, which is also relevant to the automotive industry, for synchronizing the clocks of a communication network constructed from distributed network nodes or controllers. The protocols known on the basis of this technology can also be used according to the invention, with propriety solutions, i.e., standalone network protocols for measuring the signal propagation times between the network nodes in motor vehicles, also being able to be provided, in principle.

According to a particularly preferred variant of the method proposed according to the invention, provision may be made for the signal propagation time between all network nodes of the communication network to be measured, preferably in each case as a signal propagation time between two selected network nodes. From this, it is possible to create a signal propagation time map of the communication network, for example. From that, it is simply possible to read off significant changes in the signal propagation time between the individual network nodes, for example if the signal propagation time map contains the mean signal propagation time between two network nodes and the typical fluctuation range thereof in each case. Thus, it is also a simple possibility to establish whether a signal propagation time change relates just to one specific communication link between two controllers or to the entire network. In the latter case, it is more likely that a global error in the network structure and/or network control can be assumed, whereas a sudden increase in a signal propagation time exclusively between two particular network nodes indicates the interposition of a passive reader (network analyzer, tap).

Insignificant alterations in the signal propagation time include normal, randomly occurring propagation time alterations or propagation time alterations on the basis of temperature fluctuations, which are usually small, however. It is also possible for a slight overload to occur on the network node, which delays signal receipt or the computation operations executed therefor somewhat. As a result of threshold values being simulated, such propagation time alterations can be ignored if the propagation time alterations do not exceed the stipulated threshold values.

On the basis of the cyclic measurement, it is also possible for threshold values to be derived dynamically from the cyclically recurring signal propagation time measurements, and thus for ageing of the electronic components in the vehicle to be taken into account, for example, without erroneous ratings being performed during monitoring of the communication network.

A particularly preferred embodiment of the proposed method provides for the time response of the signal propagation time between two network nodes to be analyzed and a rise in the signal propagation time, particularly exclusively between the two network nodes involved, above a threshold value of, by way of example, additionally 200 ns or another prescribed threshold value to be graded as an indication of the interposition of a network analyzer, for example in the form of a tap.

For the purpose of rating the alteration in the signal propagation time, the invention may provide for, by way of example, alterations in the signal propagation time above a threshold value to be logged, the network nodes involved, particularly in the form of even safety-relevant controllers, for example, to be deactivated, the changed signal propagation times to be communicated to the application of a network node, particularly a controller, and/or the interposition of a diagnostic device to be identified. When a diagnostic device is identified on the basis of the signal propagation time monitoring performed for the communication network, the invention can also involve a specific mode of operation of network nodes or controllers being activated.

In the case of permanently changed signal propagation times, which do not indicate an instance of monitoring that needs to be reported, it is also possible, by way of example, for the QoS (Quality of Service) requirements of the controllers involved to be adjusted in order to avoid error messages in the system and in order to inform the controllers about the signal propagation times that are to be expected, so that the signal propagation times can be taken into account as appropriate, possibly for time-critical safety applications. In addition, gateway delays between different bus systems, for example between Ethernet and a vehicle bus (CAN or the like), can be computed in advance. Furthermore, remote diagnosis of the connections via the network nodes is thus possible in order to indicate an overload on particular connections, for example in a load map of the communication network.

According to an aspect of the invention, it may also be useful to use further sensors installed in the vehicle for rating signal propagation time alterations, which if need be can explain propagation time delays that occur. A useful example of this is the antenna that is incorporated into the vehicle bus system by Ethernet, for example, and is used for vehicle-to-surroundings communication. If this antenna is very hot in the summer and the vehicle enters a carwash, in which the antenna is cooled very quickly, this can lead to performance fluctuations in electronic components of the antenna and/or in the time synchronization protocol. This can be identified by a temperature sensor in the antenna, for example, so that signal propagation time alterations as a result of a severe temperature change in the antenna can be rated accordingly.

The type of monitoring proposed overall according to the invention also helps to save on additional complex and/or computationally intensive security protocols. This relieves the overall load on the communication network.

In addition, the invention relates to network nodes, particularly controllers, of a motor vehicle that can be connected or are connected to at least one other network node or controller via an Ethernet-based communication network and have a computation unit that, according to the invention, is set up to carry out the method described above or portions thereof.

### BRIEF DESCRIPTION OF THE DRAWINGS

Further advantages, features or opportunities for application of the invention will also emerge from the description of an exemplary embodiment below and the drawings. In this case, all features described and/or graphically represented form the subject matter of the present invention on their own or in any combination, even regardless of their synopsis in the claims or the back-references therein. In the drawings:

FIG. 1 schematically shows the sequence of communication between two network nodes of an Ethernet-based communication network based on the OSI layer model;

FIG. 2 schematically shows the communication sequence between the two network nodes shown in FIG. 1 when a network analyzer is interposed in the physical layer (layer I); and

FIG. 3 shows the measurement of the signal propagation time between two network nodes in order to carry out an embodiment of the method according to the invention.

### DETAILED DESCRIPTION OF THE PRESENTLY PREFERRED EMBODIMENTS

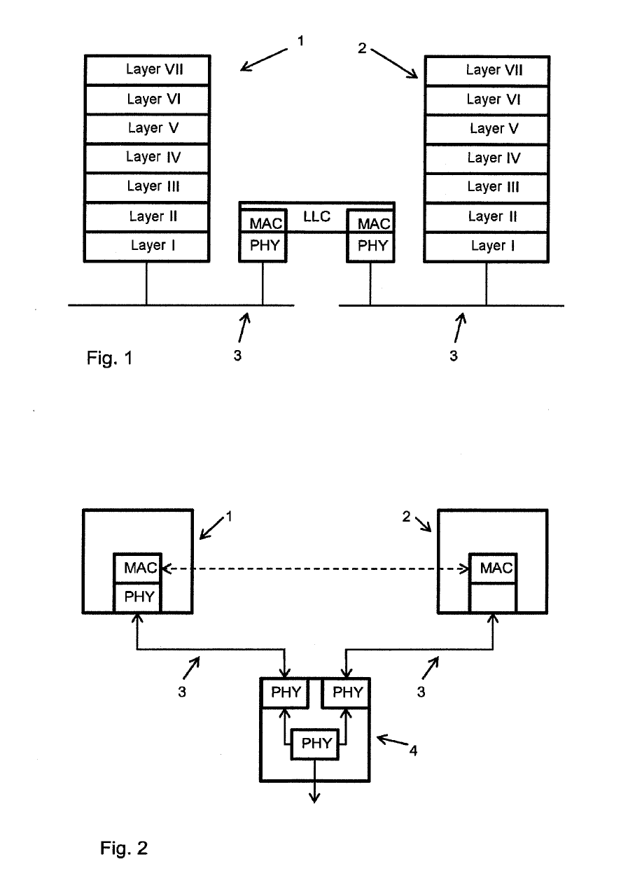

FIG. 1 schematically shows the known Ethernet-based communication, which is also used on the basis of the present invention, however, between two network nodes 1, 2, for example in the form of controllers, of a cabled communication network 3, which communication operates in a network protocol based on the OSI layer model with a total of seven layers I to VII. The tasks to be undertaken by the individual layers are implemented in computation units—not shown separately—of the network nodes 1, 2 and are shown schematically in FIG. 1.

According to the inherently known OSI layer model, the layers are denoted as follows:

Layer I: Physical layer,
Layer II: Data link layer,
Layer III: Network layer,
Layer IV: Transport layer
Layer V: Session layer,
Layer VI: Presentation layer,
Layer VII: Application layer.

Layers III to VII are used for conditioning the physically transmitted data and their association with specific applications that access the transmitted data via the application layer (layer VII). These layers are organizational in nature and have nothing to do with the physical transmission of the data or data packets. Since these layers are not affected by the present invention, a description of the content of these layers is not provided. This description is known to a person skilled in the art.

The actual data transmission takes place in layers I and II. Layer I (PHY—Physical Layer) directly contains the tools for activating and deactivating the physical connection. These include particularly devices and network components such as amplifiers, male connectors, female connectors for the network cable, repeaters, hubs, transceivers and the like. This layer I is thus used for physically addressing the transmission channel by means of suitable electrical, optical, electromagnetic or sound signals, in the case of the line-connected Ethernet communication networks usually electrical or electromagnetic signals.

The network interfaces required for physical communication are associated with each network node and form layer I based on the OSI layer model. Layer II of the OSI layer model, which is referred to as the data link layer, is used for organization and control of mostly error-free transmission and for regulation of the access to the transmission medium. This also involves the implementation of a data flow control between transmitter and receiver. Logically, the data link layer is frequently divided into media access control MAC and logical link control LLC. The media access control MAC regulates how a plurality of computers share the jointly used physical transmission medium. To this end, it uses, inter alia, what are known as the MAC addresses of the communication subscribers, which are associated with each network node as a subscriber in the communication network 3 as explicit identification. The media access control MAC is managed by the logical link control LLC by virtue of the latter distributing incoming data in each transmission direction and coordinating the access to the superordinate layers of the network control. The tasks of the media access control MAC and the logic link control LLC form what is known as the data link layer (layer II), in which the different network subscribers can be identified in order to organize the network communication in regulated fashion.

In FIG. 1, this logical management is schematically incorporated between the network nodes 1 and 2 in the line of the communication network 3 that represents the physical connection.

The only control of the network nodes 1, 2 as subscribers on the communication network thus arises in the data link layer (layer II), for example as a result of the explicit MAC addresses for identifying the individual network subscribers, which is necessary for media access control. In the physical layer (layer I), a network node 1, 2 has no knowledge of the other network nodes 2, 1 in the communication network 3, but rather controls only the physical communication on its interface to the communication network 3.

Thus, as FIG. 2 also shows, the logical organization of the network takes place in layer II (denoted here as MAC for short) of the OSI layer model between the network nodes 1 and 2. This logical management is illustrated in FIG. 2 via the dashed line between the two MAC layers of the network nodes 1 and 2.

From the schematic association of the physical connection of the communication network 3 in accordance with the solid arrows, it can be seen that it is entirely possible for the physical connection to be broken without the access control (MAC based on the data link layer or layer II) needing and being able to detect this. In this regard, each of two physical interfaces PHY has a network analyzer 4 interposed at it, which is also known as a tap (test access point).

Such a tap 4 is simply looped into the existing line connection, copies the data information or data packets on a bit-by-bit basis, without analyzing the content thereof, when the data stream is passed through, and outputs the copied data information via a further interface. The physical data stream is simply forwarded without alteration. Hence, the network analyzer 4 does not appear in the communication network 3. In particular, the data link layer (layer II of the OSI layer model) of the network nodes 1 and 2 is provided with no knowledge of the existence of the network analyzer 4.

In comparison with a direct line connection between the network nodes 1 and 2, however, the looping-through of the data stream by the network analyzer 4 leads to an extended signal propagation time for the signals (data packets) that are transmitted between the network nodes 1 and 2.

In the static communication network 3 of a motor vehicle, in which the network topology does not change if the network is not changed by intervention in an authorized workshop, it is thus possible to establish changes in the signal propagation time and thereby to establish looping-in of a network analyzer 4 that could possibly passively read the data transmitted between the network nodes 1 and 2.

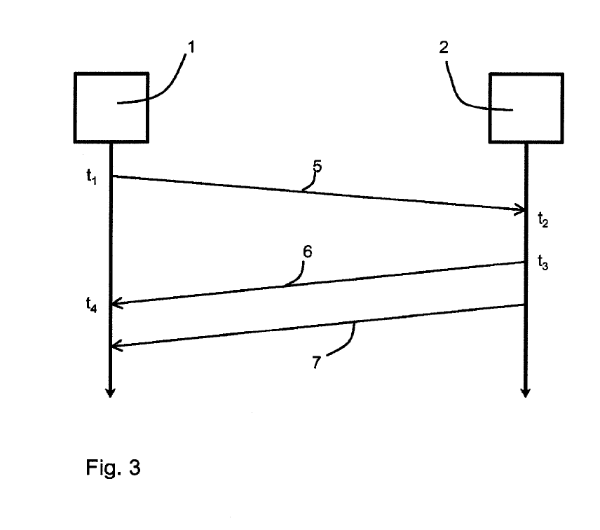

A particularly preferred possibility for measuring the signal propagation times between the network nodes 1 and 2 in this context is shown schematically in FIG. 3.

Starting from each of the network nodes 1 and 2, parallel downwardly directed timelines are shown between which communication for measuring the signal propagation times between the network nodes 1 and 2 has its time characteristic represented by arrows.

The one network node 1, which is subsequently also referred to as the sending network node 1, sends a query message 5, which contains its own transmission time as a transmission time stamp t₁, for the purpose of measuring the signal propagation time. This transmission time stamp t₁ is added to the signal (data packet) by the transmitter or transceiver of the network node 1 immediately prior to the physical sending of the data, so that said transmission time stamp t₁ defines the actual transmission time to a good approximation. The other network node 2, subsequently also referred to as the receiving network node 2, logs the reception time as a reception time stamp t₂ and transmits the reception time stamp t₂ in a response message 6 to the one (originally sending) network node 1. At the same time, the other, originally receiving network node 2 logs the transmission time of the response message 6 as a response time stamp t₃ and transmits said response time stamp t₃ in a follow-up response message 7 to the one, originally sending network node 1.

The one network node 1 additionally logs the reception time of the response message 6 as a response reception time stamp t₄, so that both the signal propagation time from the network node 1 to the network node 2 and the signal propagation time from the network node 2 to the network node 1 can be established by suitable difference formation.

These measurements take place cyclically, i.e. at prescribed intervals of time of, by way of example, from 100 ms to several seconds or minutes. An interval of time that is preferred according to the invention is in the order of magnitude of approximately 1 second, because a message at this frequency, i.e., at this interval of time, does not severely lower the Ethernet network.

In addition, it is useful to perform such signal propagation time measurements between all communicatively interconnected network nodes 1, 2 of the communication network 3, preferably in each case as a direct signal propagation time between two network nodes 1, 2.

As a result of this and/or as a result of preprogramming in production when the vehicle is first commissioned, the typical signal propagation times between all network nodes 1, 2 are known in each case, so that when the signal propagation time is extended by 200 ns from 400 ns to 600 ns, for example, it is possible to infer the interposition of a network analyzer 4 or a similar device.

It is particularly useful to create a signal propagation time map of the communication network 3, which signal propagation time map stipulates the typical signal propagation times with their typical fluctuation range. By evaluating the changes, it may thus be possible to establish whether a network analyzer 4 has been looped in, there is another kind of disturbance in the network or a diagnostic device has been interposed. In that case, certain controllers can be switched to a diagnosis mode, for example. By way of example, the interposition of diagnostic devices can be identified by virtue of the signal propagation times between two particular network nodes 1, 2 being extended by a defined amount.

Both the network nodes 1, 2 and the defined extension are preferably known to the monitoring of the communication network.

In principle, the distinction between a “good” device, which is used as a diagnostic device, for example, and a “bad” device, which taps off the communication data without authorization, can be made on the basis of several principles.

By way of example, network nodes that are involved can be notified of a new altered signal propagation time in a workshop, for example, so that changes made to the communication network purposefully and with authorization do not lead to false alarms. In addition, by calling a diagnosis mode, as is typical for controllers, the function of monitoring of the communication link can, preferably temporarily, be deactivated or the threshold value could be altered. If the interposition is meant to be effected dynamically, however, this could be flagged by specific coding, for example by virtue of the diagnostic device being hooked into the network, unhooked, hooked in, unhooked, . . . (or switched on/off/on/off/on alternately at short intervals and in so doing at certain times between the changeover times being observed, in a similar manner to Morse code. By virtue of specific certification in the protocols on higher layers of the OSI layer model, the diagnostic device can then be verified as such. In this way, communication partners on higher layers are typically authenticated. This is borne in mind and checked when the threshold values are exceeded.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A method for monitoring an Ethernet-based communication network (3) in a motor vehicle, comprising:
monitoring a communication link between a first network node (1) and a second network node (2) connected to one another via the communication network (3);
measuring bidirectionally and cyclically a signal propagation time for signals between the first and second network nodes (1, 2) of the communication network (3); and
rating changes in the signal propagation time.

10. The method as claimed in claim 9, wherein in the step of measuring the signal propagation time, the first network node (1) sends a query message (5) to the second network node (2), which query message (5) contains a transmission time (t1), and the second network node (2) logs a reception time (t2).

11. The method as claimed in claim 10, wherein the second network node (2) sends to the first network node (1) a response message (6) with the reception time (t2) of the query message (5).

12. The method as claimed in claim 11, wherein the second network node (2) logs a response message transmission time (t3) of the response message (6) and sends a follow-up response message (7) to the first network node (1) with the response message transmission time (t3), wherein the first network node (1) logs a follow-up response message reception time (t4) of the response message (7).

13. The method as claimed in claim 9, wherein the communication network comprises further network notes and the method further comprises measuring signal propagation times between all network nodes of the communication network.

14. The method as claimed in claim 9, further comprising:
analyzing a time response of the signal propagation time between the first and second network nodes (1, 2); and
grading a rise in the signal propagation time above a threshold value as an indication of interposition of a network analyzer (4) in the communication network.

15. The method as claimed in claim 9, further comprising:
logging alterations in the signal propagation time;
deactivating network nodes associated with the alterations;
communicating the altered signal propagation times to an application of a network node and/or identifying the interposition of a diagnostic device; and
activating a specific mode of operation of the first and second network nodes (1, 2).

16. A network node in a motor vehicle, the network node being connectable to at least one other network node via an Ethernet-based communication network (3) and having a computation unit, wherein the computation unit of the network node is configured to carry out the method as claimed in claim 9.
